(19) United States
(12) Patent Application Publication
(10) Pub. No.: US 2012/0169485 A1
(43) Pub. Date: Jul. 5, 2012

(54) Industrial Tool

(75) Inventor: Martin Eckert, Neuenstein (DE)

(73) Assignee: Robert Bosch GmbH, Stuttgart (DE)

(21) Appl. No.: 13/337,199

(22) Filed: Dec. 26, 2011

(30) Foreign Application Priority Data
Dec. 30, 2010 (DE) 10 2010 056 498.2
Jul. 29, 2011 (DE) 10 2011 108 963.6

(51) Int. Cl. G08C 19/12

(52) U.S. Cl. 340/13.25

(57) ABSTRACT

An industrial and electrically driven tool includes two mutually independent radio modules so that a redundant communication link to a controller can be set up.

This application claims priority under 35 U.S.C. §119 to both (i) patent application no. DE 10 2010 056 498.2, filed on Dec. 30, 2010 in Germany, and (ii) DE 10 2011 108 963.6, filed on Jul. 29, 2011 in Germany. The disclosures of the above-identified patent applications are both incorporated herein by reference in their entirety.

### BACKGROUND

The disclosure relates to an industrial and electrically driven tool for mobile use. In particular, the disclosure relates to a storage-battery-operated screwing tool, as is shown in the specification WO 2008/088266, for example, the disclosure of which is incorporated herein by reference in its entirety.

The specification WO 2008/088266 discloses a portable screwing tool which uses operating parameters prescribed by a screwing controller to perform screwing operations. These operating parameters are transmitted to the screwing tool by the screwing controller wirelessly by radio.

Since there are a large number of radio transmission systems, which in some cases are also customer specific, the screwing tool shown here provides the option of interchanging the radio module which the screwing tool comprises for the purpose of radio transmission. A user is therefore able to change from WLAN mode to Bluetooth mode, for example, by replacing the WLAN module with a Bluetooth module.

However, both WLAN and Bluetooth, and also other private mobile radio devices, have only a limited range. If the tool is outside of this range then configuration and monitoring by the screwing controller are no longer possible.

However, minimum requirements are defined for the monitoring of screwing systems and screwing processes by means of norms and standards, this involving the consideration of different categories which relate to the risk in the event of the screw joint failing.

Category A: indirect/direct danger to life and limb
Category B: breakdown
Category C: annoyance for the customer

These categories play an important part particularly in automotive engineering. Safety-relevant screw joints need to be counted, documented and screwed together using the correct initial stressing force. To ensure this, intensive communication between screwing tool and screwing controller is required.

The communication link required for this communication should therefore be implemented as reliably as possible.

### SUMMARY

The disclosure relates to an industrial and electrically driven tool for mobile use, particularly a storage-battery-operated screwing tool. Any other industrially used tool for which it is necessary to document the work steps would likewise be conceivable (for example resistance welding equipment, riveting tools and the like).

The tool according to the disclosure comprises a housing having an integrated tool controller and an integrated first radio module for the tool controller to communicate with a device which is remote from the tool within a predefined radio frequency band.

The housing comprises an additional second radio module, which operates using a different radio frequency range than the radio frequency range of the first radio module.

If a radio network which is required for the operation of the tool fails or if the tool is outside of the range of the radio network, the second radio module can be used to automatically change over to a different radio network, possibly with a greater range, if the transmission power for the operation of the first radio module decreases or if the tool is in a radio hole which is critical for the transmission frequency of the first radio module. The standardization of the production processes performed using the tools while simultaneously increasing process safety therefore continues to remain assured.

Preferably, the second radio module is implemented such that a communication link is set up using frequencies from the radio frequency range provided for terrestrial or satellite-based mobile radio, particularly on the basis of one of the GSM standards and/or the UMTS standard.

Identical parameterization for the same instances of screwing can therefore be guaranteed worldwide, even at locations at which self-contained production sites cannot assure adequate radio coverage. By way of example, steering systems on a vehicle model which is produced at different locations could be assembled using the same screwing system and the same tightening parameters. The only prerequisite is the presence of a mobile radio network. It would even be possible to dispense with a separate Internet connection, since the Internet could also be used via the mobile radio network. For this situation, the tool would also need to be equipped with a means which allows the allocation of an IP address which the tool controller could use at least temporarily to communicate with a superordinate process controller, for example, via the Internet.

The second radio module uses at least one of the following radio frequency ranges or an intermediate range included therein: 876-915 MHz and/or 921-960 MHz and/or 1710-1785 MHz and/or 1805-1880 MHz and/or 1850-1910 MHz and/or 1930-1990 MHz, in order to ensure connection by means of GSM (GSM 800/850/900/1800 or 1900 standards are supported).

Alternatively or in addition, the second radio module uses at least the following radio frequency range or intermediate ranges included therein: 1900-2170 MHz for UMTS compatibility. It goes without saying that it is also possible to provide radio modules which use future planned radio ranges for terrestrial and/or satellite-based mobile telephony.

Preferably, a first means is provided which the tool controller uses to recognize which radio link is used by the device. In addition, a second means is provided which the tool controller is able to use to automatically activate one of the two radio modules. To this end, it would be possible, by way of example, for the transmission power of the radio network used to be monitored permanently, with a drop below a predefined transmission level prompting changeover from the first to the second radio module or additionally activation of the second radio module and the latter being used to set up an alternative or additional connection to the superordinate process controller. The process controller can then use both or one of the two radio modules to communicate with the tool.

The tool preferably has means provided on it which ensure that at least one of the radio modules can be easily interchanged without needing to open the housing of the tool. For these purposes, the housing could comprise a cutout with a contact connection for both or one of the two radio modules.

The tool also has a means provided on it which allows manual changeover between both radio modules. This allows the user to change over quite consciously from a WLAN connection to a UMTS connection, for example, if it is known from the outset that there is only a UMTS network available at the location at which the tool is used. A symbol which can be displayed on the display which the tool comprises could make the user aware of the different radio networks which are present.

Features of the disclosure also include a device for mobile use, comprising an integrated radio module. The radio module is implemented such that frequencies from a radio frequency band provided for terrestrial or for satellite-based mobile radio can be used. The device comprises means for configuring a tool, which means are implemented such that it is possible to implement data interchange between a tool controller which the tool comprises using a corresponding radio module which the tool likewise comprises. The device used could be mobile telephones, for example, which allow user-specific program modules to run on the operating system used by the mobile telephone or the firmware used by the mobile telephone. It would also be possible to use SMS or EMAIL services for communication.

The disclosure therefore provides a complete system for performing automated industrial processes, particularly screwing processes. The system according to the disclosure comprises a device and a tool and therefore combines the advantages already described above.

Features of the disclosure also include a method for operating a tool having an integrated tool controller and having two independently operating integrated radio modules using a device which is distantly remote from the tool and which likewise has an integrated radio module. The radio module of the device is compatible with at least one radio module of the tool which using a predefined radio frequency band within a radio frequency range provided for terrestrial or satellite-based mobile radio.

The device or the tool uses the GSM service GPRS, or uses services of the same kind which are used by other mobile radio standards, to set up a connection to the tool. The tool controller is used to interchange data. The device can request and send data. The data requested by means of the device are stored on a data memory which the device comprises and are therefore documented. This may involve screwing operations that require documenting, for example, if the tool is an industrial screwdriver.

The data stored on the data memory can be changed by a user using an operator control device which the device comprises, for example if they are parameters for the tool controller or parameters for configuring the tool (IP address, GSM data server, WPA key, GSM data server). The tool therefore becomes remotely maintainable. The tool and the device are therefore able to interchange all data which relate to processes to be performed by the tool or to the configuration of the tool or to diagnosis data for clearing interference on the tool.

The first or the second radio module is activated fully automatically and autonomously by the tool controller as soon as the radio network which is required for the second or the first radio module no longer provides adequate transmission power. Hence, a redundant communication link between tool controller and superordinate process controller is assured for the interchange of data.

### BRIEF DESCRIPTION OF THE DRAWINGS

FIG. 1 shows a highly schematic view of the way in which features of the disclosure work.

FIG. 2 shows a screwing tool having the features of the disclosure.

### DETAILED DESCRIPTION

None of the embodiments described below restrict the disclosure to the design details mentioned. They are merely possible and preferred variant embodiments. Different solution concepts using possibilities known from the prior art could likewise be implemented.

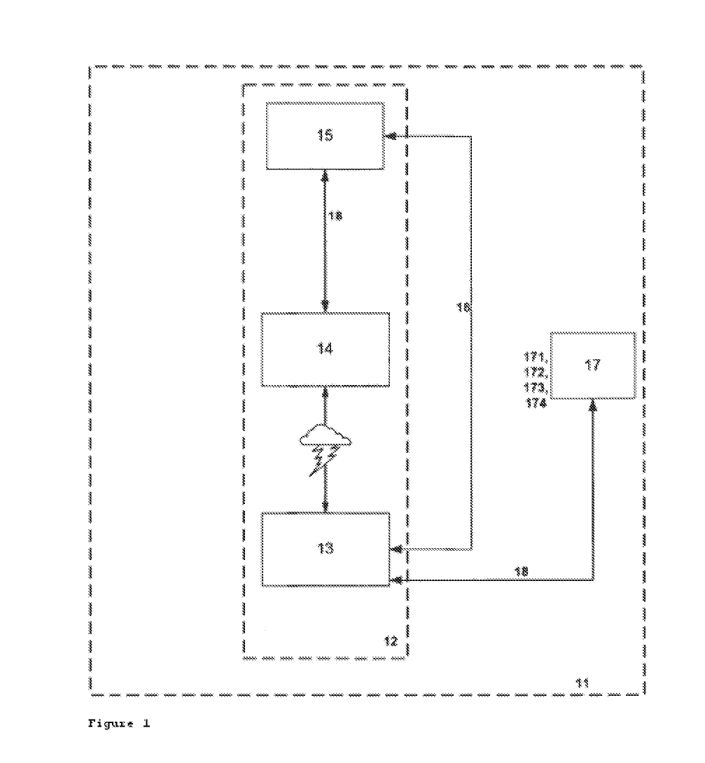

FIG. 1 shows a system for performing automated industrial screwing processes having a device 17 and a screwing tool 13. The device 17 is a mobile telephone having a user-specific program and also customary components such as a keypad, display, etc. 171-174 for configuring the screwing tool 13. The program 172 is designed such that it implements data interchange between a tool controller (not shown) which the tool 13 comprises using a corresponding radio module (not shown) which the tool 13 likewise comprises. The screwing tool is storage-battery-operated and comprises a standard data interface (WLAN, Bluetooth and the like). By means of the standard data interface, what is known as an access point 14, which may be installed on the company premises of a production operation, can be used to remotely control the screwing tools.

The remote control is effected using a superordinate screwing process control unit. The access point 14 defines the coverage of the company premises using a first radio network 12. The superordinate screwing process control unit can use the radio network 12 to access the screwing tools and to store data which are specific to the screwing tools on a data memory which the screwing process control unit 15 comprises. The data interchanged wirelessly 18 in the mobile radio network 11 are preferably data concerning:
screwing parameters;
screwing tool configuration data;
screwing tool diagnosis data;
screwing results.

The modifications according to the disclosure also allow the communication between a screwing tool and a screwing process control unit to be effected using the worldwide available mobile radio network, i.e. including using a mobile telephone, which in this case serves as a temporary screwing process control unit or as a sole screwing process control unit.

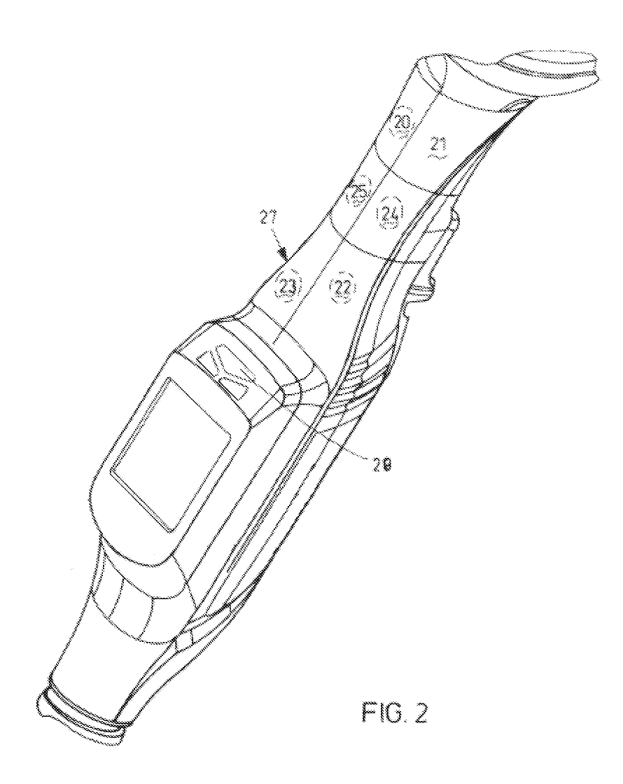

FIG. 2 shows a subsection of an industrially and electrically driven screwing tool. The tool comprises a housing 21 having an integrated tool controller 22 and an integrated first WLAN/Bluetooth radio module 23 for the tool controller 22 to communicate with a device (not shown—in this regard see FIG. 1) arranged distantly remote from the tool within predefined radio frequency ranges. The housing 21 comprises a second GSM/UMTS radio module 24 and therefore sets up a communication link using frequencies which are provided for terrestrial mobile radio, particularly 876-915 MHz and/or 921-960 MHz and/or 1710-1785 MHz and/or 1805-1880 MHz and/or 1850-1910 MHz and/or 1930-1990 MHz and/or alternatively 1900-2170 MHz.

A radio link monitoring element 25 is provided which the tool controller 22 uses to recognize which radio link is currently used by a superordinate screwing process control unit, in order to incorporate the screwing tool 21 into the screwing process which can be prescribed by the screwing process control unit.

A radio module changeover means 26 is likewise provided which the tool controller 22 is able to use to activate one of the two radio modules 23, 24 fully automatically and possibly using the radio link monitoring element 25. The first or the second radio module 23, 24 can therefore be activated fully automatically and autonomously by the tool controller 22, because the radio module changeover means 26 which the tool 21 comprises monitors and recognizes the transmission power of the radio networks which can be used as soon as the radio network which is required for the second or the first radio module 23, 24 no longer provides adequate transmission power.

A keypad 28 is also provided which allows manual changeover between both radio modules 23, 24.

The tool 21 has cutouts and plug connections 27 provided on it which ensure that at least one of the radio modules 23, 24 can be interchanged without needing to open the housing 21 of the tool. To this end, at least one recess is provided on the housing 21 and comprises electrical connections which correspond to the electrical connections on at least one of the radio modules 23, 24. At least one of the radio modules 23, 24 can be positioned in the recess such that the surface of the radio module 23, 24 and the surface of the housing 21 form a continuous surface. The points of contact with the housing should be tightly sealed (e.g. rubber lip), so that no accumulations of dirt or moisture can penetrate the recess.

The screwing tool is configured by mobile telephone. The mobile telephone uses the GSM service GPRS to set up a connection to the tool. The current configuration of the tool is loaded onto the mobile telephone. The user now has the opportunity to customize the configuration. The configuration includes general settings, such as the IP address, WPA key, telephone number of a GSM data server and the like. It is likewise possible to configure the screwing programs. When the changes are complete, the configuration can be sent to the screwing tool again.

Screwing process data are retrieved by mobile telephone. The mobile telephone uses the GSM service GPRS to set up a connection to the tool and reads the currently available screwing results. While the connection exists, new available screwing process data can be automatically transmitted to the mobile telephone. In the configuration, it is possible to set whether the data are erased or retained on the screwing tool following retrieval by mobile telephone.

For the purpose of transmitting screwing process data to a data server, said data are transmitted using the GSM service GPRS or an SMS, depending on the data packet size. The data server converts the data obtained into the format required by the operator of the screwing tool and forwards said data to a previously configured customer database.

In comparison with previously known solutions, it is possible to use the tool according to the disclosure largely without restriction outside of assembly lines, for example including in open country. Radio frequencies already in use from known standards in the environment of the assembly lines and the bandwidths thereof do not need to be used for operating the tool. Accordingly, operation of the tool also cannot interfere with these radio frequencies or block them to the detriment of other radio-operated equipment.

What is claimed is:

1. An industrial and electrically driven tool for mobile use, comprising a housing having an integrated tool controller and an integrated first radio module for the tool controller to communicate with a device arranged remotely from the tool within a predefined radio frequency range,
wherein the housing comprises a second radio module, which operates using a different radio frequency range than the radio frequency range of the first radio module.

2. The tool as claimed in claim 1, wherein the second radio module is implemented such that a communication link is set up using frequencies from radio frequency ranges provided for terrestrial or satellite-based mobile radio.

3. The tool as claimed in claim 1, wherein the second radio module uses at least one of the following radio frequency ranges or an intermediate frequency range covered by these ranges: 876-915 MHz and/or 921-960 MHz and/or 1710-1785 MHz and/or 1805-1880 MHz and/or 1850-1910 MHz and/or 1930-1990 MHz.

4. The tool as claimed in claim 1, wherein the second radio module uses at least the following radio frequency range or an intermediate frequency range included therein: 1900-2170 MHz.

5. The tool as claimed in claim 1, wherein a first mechanism is provided which the tool controller uses to recognize which radio frequency range is used by the device.

6. The tool as claimed in claim 1, wherein a second mechanism is provided which the tool controller is able to use to automatically activate one of the two radio modules.

7. The tool as claimed in claim 1, wherein the tool has a mechanism provided on it which ensures that at least one of the radio modules can be interchanged without needing to open the housing of the tool.

8. The tool as claimed in claim 1, wherein the tool has a mechanism provided on it which allows manual changeover between both radio modules.

9. A device for mobile use, comprising an integrated radio module which is implemented such that frequencies from radio frequency ranges provided for terrestrial or satellite-based mobile radio are used, wherein the device comprises a mechanism for configuring a tool, which mechanism is implemented such that it is possible to implement data interchange between a tool controller which the tool comprises using a corresponding radio module which the tool likewise comprises.

10. A method for operating a tool having an integrated tool controller and two independently operating radio modules using a device which is arranged distantly from the tool and which has an integrated radio module, which is compatible with at least one radio module of the tool, using a predefined radio frequency range within a radio frequency band provided for terrestrial or satellite-based mobile radio.

11. The method as claimed in claim 10, wherein the device uses the GSM service GPRS to set up a connection to the tool and to request, receive or send data from the tool controller.

12. The method as claimed in claim 11, wherein the data requested by a mechanism of the device is stored on a data memory which the device comprises.

13. The method as claimed in claim 12, wherein the data stored on the data memory are changed by a user input using an operator control device which the device comprises.

14. The method as claimed in claim 10, wherein the tool and the device interchange data which relate to at least one process to be performed by the tool or to the configuration of the tool or to diagnosis data for clearing interference on the tool.

15. The method as claimed in claim 10, wherein the method involves remote maintenance of the tool being performed.

16. The method as claimed in claim 10, wherein the method involves the work steps performed by a mechanism of the tool being documented.

17. The method as claimed in claim 10, wherein the first or the second radio module is activated fully automatically and autonomously by the tool controller as soon as the radio network which is required for the second or the first radio module no longer provides adequate transmission power for interference-free communication with the tool.

18. The tool according to claim 1, wherein the tool is a storage-battery-operated screwing tool.
